(19) United States
(12) Patent Application Publication
(10) Pub. No.: US 2009/0073873 A1
(43) Pub. Date: Mar. 19, 2009

(54) Multiple path switch and switching algorithms

(75) Inventors: Angus David MacAdam, Suwanee, GA (US); Robert H. Bishop, Suwanee, GA (US)

Correspondence Address: Roeder & Broder LLP, 5560 Chelsea Avenue, La Jolla, CA, 92037, US

(73) Assignee: Integrated Device Technology, Inc.

(21) Appl. No.: 11/901,419

(22) Filed: Sep. 17, 2007

(51) Int. Cl. G08C 15/00

(52) U.S. Cl. 370/219

(57) ABSTRACT

A data switch (14) for transferring data includes an A port group (34A), a B port group (34B), and an AB connector (52). The A port group (34A) includes an A interface (44), a first A port (36) that is electrically connected to the A interface (44), and a second A port (36) that is electrically connected to the A interface (44). The B port group (34B) includes a B interface (46), a first B port (38) that is electrically connected to the B interface (46), and a second B port (38) that is electrically connected to the B interface (46). The AB connector (52) directly connects the A interface (44) to the B interface (46) so that data from first A port (36) is transferred from the A interface (44) to the B interface (46) via the AB connector (52). Additionally, the data switch (14) includes switching algorithms that control the transfer of data packets between the ports (36)-(42). The switching algorithms can transfer the data packets in a burst fashion. Further, the switching algorithms can stop the burst fashion in certain circumstances.

### BACKGROUND

Switches are commonly used to transfer information. A common, prior art mesh switch architecture is illustrated in FIG. 1. This switch includes a plurality of ports, (for example, ports 0-7 in FIG. 1), connectors 1 from every port to every other port, including itself, in the switch, and a centralized control system 2 that controls the transfer of information between the ports. This type of architecture can have very high bandwidth because of the amount of data that can be flowing through the switch in parallel. Unfortunately, the switch can also be very large. In particular, the wires that are required to implement a mesh architecture with any more than a few ports can become a significant contributor to the overall size of the switch. Further, the centralized control system 2 can become backlogged and this can slow down the transfer of data between the ports.

### SUMMARY

The present invention is directed toward a data switch for transferring data. In one embodiment, the data switch includes an A port group, a B port group, and an AB connector. In this embodiment, the A port group includes an A interface, a first A port that is electrically connected to the A interface, and a second A port that is electrically connected to the A interface. The B port group includes a B interface, a first B port that is electrically connected to the B interface, and a second B port that is electrically connected to the B interface. Further, the AB connector directly connects the A interface to the B interface so that data from first A port is transferred from the A interface to the B interface via the AB connector.

With this design, in certain embodiments, because the AB connector services a number of ports, the switch can have a large number of ports with a relatively small form factor. Further, this switch architecture can have very high bandwidth because of the amount of data that can be flowing through the switch in parallel.

Additionally, the data switch can include a C port group that includes a C interface, a first C port that is electrically connected to the C interface, and a second C port that is electrically connected to the C interface. In this embodiment, the data switch can also include an AC connector that directly connects the A interface to the C interface, and a BC connector that directly connects the B interface to the C interface.

Further, the data switch can include a D port group that includes a D interface, a first D port that is electrically connected to the D interface, and a second D port that is electrically connected to the D interface. In this embodiment, the data switch can include an AD connector that directly connects the A interface to the D interface, a BD connector that directly connects the B interface to the D interface, and a CD connector that directly connects the C interface to the D interface.

In one embodiment, each of the connectors has enough bandwidth to support a maximum combined input bandwidth of the respective ports. With this design, the switch supports parallel data transfer between the ports.

Further, one or more of the port groups can include more than two ports. For example, one or more of the port groups can include three, four, or five ports that are connected to the respective interface.

In one embodiment, each of the ports includes an input buffer and an output buffer. Moreover, the data switch can include a control system that utilizes a switching algorithm that controls the transfer of data packets between the ports. For example, the control system can be a distributed, decentralized system that includes a port control system at each port that controls the transfer of data.

In one embodiment, the switching algorithm includes a burst read function that causes each of the ports to sequentially send all of the data packets in each input buffer, per priority, without waiting for a response. The burst read function can provide a significant performance increase in randomized data packet traffic as it allows the data packets to be transmitted when otherwise those packets could be blocked by a packet at the front of the queue that is waiting for a congestion at its intended destination port to be resolved.

In certain embodiments, if the first A port is attempting to send a first data packet to the first B port at the same time that the second A port is attempting to send a second data packet (with the same priority as the first data packet) to the first B port, the switching algorithm stops the burst read function so that the second A port stops sending the second A data packet until an acceptance is received by the first A port. Stated in another fashion, if two source ports of a particular port group are attempting to send data to the same destination port with the same priority, the switching algorithm stops one of the source ports from sending the data to the destination port until the other data has been sent. With this design, the bandwidth reserved for the second A port can be used by the first A port to transfer the first data packet to expedite the data transfer to the first B port.

In another embodiment, if the first A port is attempting to sequentially send a first data packet and a second data packet (with the same priority) to the first B port, the switching algorithm stops the burst function if an abort is received for the first data packet and waits until an acknowledgement is received for the first data packet prior to attempting to send the second data packet. Stated in another fashion, if one of the ports has a plurality of data packets to send to the same destination port, with the same priority, if an abort is received, the switching algorithm waits for the acknowledgement from the destination port prior to sending the next data packet. With this design, the switching algorithm prevents the data packets that are out of order from being sent because these out of order data packets will not be accepted out of order and these out of order data packets, if sent, will use resources that can be allocated for sending other packets.

The present invention is also directed to a switching algorithm and a method for transferring data.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in Which:

FIG. 1 is a simplified illustration of a prior art switch;

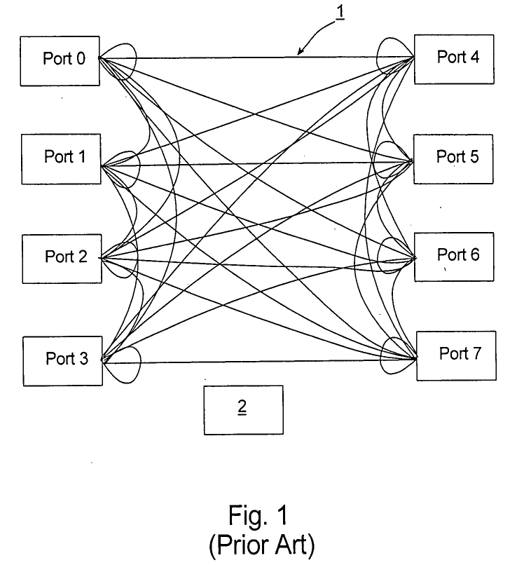

FIG. 2 is a simplified illustration of an integrated circuit including a switch having features of the present;

FIG. 3 is a simplified illustration of a portion of the integrated circuit of FIG. 2 illustrating a transmission of a data packet;

FIG. 4 is a simplified illustration of the upstream logic and the downstream logic for an interface of the switch of FIG. 2;

FIG. 5 is a simplified illustration of the upstream logic for the interface;

FIG. 6 is a simplified illustration of the downstream logic for the interface;

FIGS. 7-10 are alternative flows of a data packet and its potential unique responses;

FIGS. 11 and 12 illustrate the flow of the upstream protocol enforcement logic; and

FIG. 13 illustrated the flow of the downstream protocol enforcement logic.

### DESCRIPTION

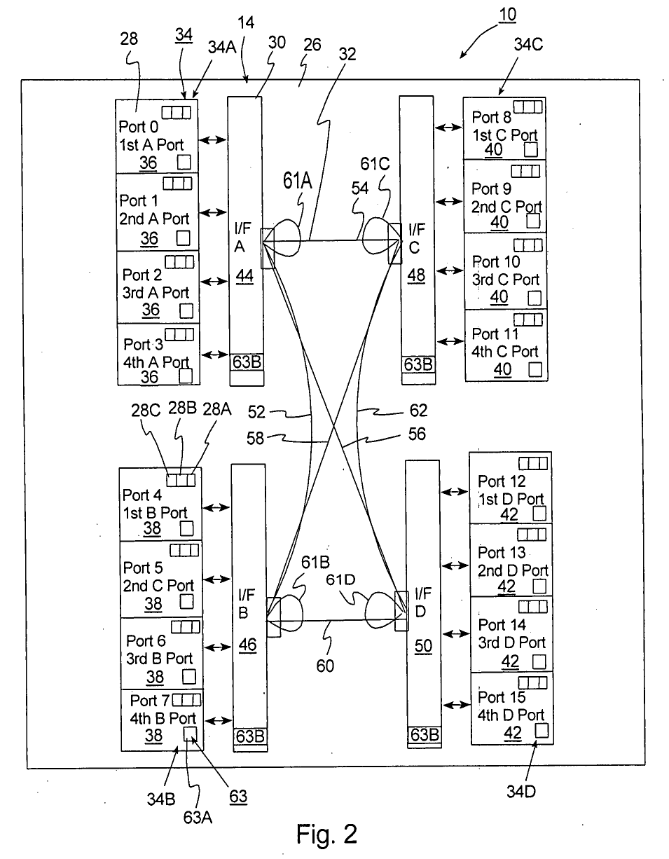

FIG. 2 is a simplified illustration of an integrated circuit 10; and one non-exclusive embodiment of a data switch 14 having features of the present invention that is electrically connected to the integrated circuit 10. With this design, the data switch 14 is used to transfer data to the integrated circuit 10. As an overview, in certain embodiments, the switch 14 is uniquely designed to quickly and efficiently transfer data and to have a relatively small form factor. Additionally, in certain embodiment, the switch 14 utilizes a unique switching algorithm that provides high bandwidth.

In one embodiment, the switch 14 includes a plurality of ports 28, a plurality of interfaces (“I/F”) 30, and a plurality of electrical connectors 32. The design of each of these components can vary pursuant to the teachings provided herein. As an overview, in FIG. 2, the switch 14 takes advantage of the parallel nature of the mesh architecture while reducing the number of electrical connectors 32 to reduce the overall size of the switch 14. In this embodiment, instead of using dedicated electrical connectors (not shown) from every port 28 to every other port 28, the present invention groups a number of ports 28 together into separate port groups 34. These port groups 34 are then connected with electrical connectors 32 in a mesh architecture, with every port group 34 being connected to every other port group 34.

In one embodiment, the integrated circuit 10 supports the components of the switch 14.

Each of the ports 28 provides a connector point for connecting the switch 14 to the integrated circuit 10. The number of ports 28 in the switch 14 can be changed to achieve the design requirements of the switch 14. In FIG. 2, the switch 14 includes sixteen ports 28 (labeled ports 0-15). Alternatively, the switch 14 can be designed with more than sixteen or fewer than sixteen ports 28. In FIG. 2, the ports 28 have been organized into four port groups 34, namely, an A port group 34A, a B port group 34B, a C port group 34C, and a D port group 34D. Further, in FIG. 2, each of the port groups 34A-34D includes four ports 28. Alternatively, depending upon the design requirements of the switch 14, the ports 28 can be divided into more than four or fewer than four port groups 34A-34D, and/or one or more of the port groups 34A-34D can include more than four or fewer than four ports 28.

In FIG. 2, (i) the ports 28 of the A port group 34A are also labeled the A ports 36 (including ports 0-3); (ii) the ports 28 of the B port group 34B are also labeled the B ports 38 (including ports 4-7); (iii) the ports 28 of the C port group 34C are also labeled the C ports 40 (including port 8-11); and (iv) the ports 28 of the D port group 34D are also labeled the D ports 42 (ports 12-15). It should be noted that (i) the four A ports 36 labeled ports 0-3 can also respectively be referred to as the first A port, the second A port, the third A port, and the fourth A port; (ii) the four B ports 38 labeled ports 4-7 can also respectively be referred to as the first B port, the second B port, the third B port, and the fourth B port; (iii) the four C ports 40 labeled ports 8-11 can also respectively be referred to as the first C port, the second C port, the third C port, and the fourth C port; and (iv) the four D ports 42 labeled ports 12-15 can also respectively be referred to as the first D port, the second D port, the third D port, and the fourth D port.

In one embodiment, each of the ports 28 includes an output buffer 28A that provides temporary storage of data that is leaving the respective port 28 and an input buffer 28B that provides temporary storage of data arriving at the respective port. In one embodiment, there is a separate memory for each priority data packet. Alternatively, portions of a single memory can be used for each priority data packet.

Further, each port 28 can include a packet tracker 28C (sometimes referred to as a Protocol Enforcement “PE” Buffer) that tracks a certain number of packets. For example, the packet tracker 28C can track four packets per priority, per port. Alternatively, the packet tracker 28C can be designed to track more than four or fewer than four packets per priority, per port.

The number of interfaces 30 used in the switch 14 can be varied according to the number of port groups 34A-34D. In certain embodiments, each port group 34A-34D includes an interface 30. Thus, the number of interfaces 30 is equal to the number of port groups 34A-34D. Alternatively, the switch 14 can be designed with more than four or fewer than four interfaces 30.

In FIG. 2, the interfaces 30 can be referred to as the A interface 44, the B interface 46, the C interface 48, and the D interface 50. In this embodiment, (i) the A interface 44 is part of the A port group 34A, is directly electrically connected to and services the four A ports 36; (ii) the B interface 46 is part of the B port group 34B, is directly electrically connected to and services the four B ports 38; (iii) the C interface 48 is part of the C port group 34C, is directly electrically connected to and services the four C ports 40; and (iv) the D interface 50 is part of the D port group 34D, is directly electrically connected to and services the four D ports 42. In one embodiment, each of the interfaces 44-50 includes logic that controls the transfer of data between the ports 28. The operation of the interfaces 30 is described in more detail below.

The number of connectors 32 used in the switch 14 can be varied according to the number of interfaces 30. In FIG. 2, the switch 14 includes ten connectors 32 that can be named an AB connector 52, an AC connector 54, an AD connector 56, a BC connector 58, a BD connector 60, a CD connector 62, an AA connector 61A, a BB connector 61B, a CC connector 61C, and a DD connector 61D. In this embodiment, (i) the AB connector 52 directly connects the A interface 44 to the B interface 46; (ii) the AC connector 54 directly connects the A interface 44 to the C interface 48; (iii) the AD connector 56 directly connects the A interface 44 to the D interface 50; (iv) the BC connector 58 directly connects the B interface 46 to the C interface 48; (v) the BD connector 60 directly connects the B interface 46 to the D interface 50; (vi) the CD connector 62 directly connects the C interface 48 to the D interface 50, (vii) the AA connector 61A loops back and directly connects the A interface 44 to the A interface 44, (viii) the BB connector 61B loops back and directly connects the B interface 46 to the B interface 46, (ix) the CC connector 61C loops back and directly connects the C interface 48 to the C interface 48, and (x) the DD connector 61D loops back and directly connects the D interface 50 to the D interface 50.

In one embodiment, the connectors 32 between interfaces 30 have enough bandwidth to support the aggregate bandwidth of the ports 28 in the port group 34. For example, the bandwidth of the connectors 32 can be time-sliced so that all ports 28 in each port group 34 have a dedicated portion of the connector 32 bandwidth, each portion of which is large enough to support the maximum bandwidth that the port 28 can provide. In this way, the parallel data transfer advantage in bandwidth that is achieved in the traditional mesh architecture is maintained while the number of connectors 32 required can be reduced to make this hybrid architecture more size-efficient.

As one non-exclusive example, each interface 30 can have a bandwidth of approximately 10 gigabits/second. In this example, if all of the ports 28 of a particular interface 30 have data to transmit, each of the ports 28 would get 2.5 gigabits/second for a 10 gigabit/second system. Alternatively, (i) if only three ports 28 have data to transmit, each of the ports 28 would get 3.3 gigabits/second for a 10 gigabit/second system, (ii) if only two ports 28 have data to transmit, each of the ports 28 would get 5 gigabits/second for a 10 gigabit/second system, or (iii) if only one port 28 has data to transmit, this port 28 would get 10 gigabits/second for a 10 gigabit/second system.

Additionally, the switch 14 includes a switch control system 63 that controls the transfer of each data packet in the switch 14. In one embodiment, the switch control system 63 is a distributed, decentralized control system with each port 28 including a separate port control system 63A. In this embodiment, each port control system 63A can independently make decisions regarding its port, in parallel with the other port control systems 63A. Additionally, each of the interfaces 30 can also includes an interface control system 63B that controls the flow of data to and from that interface 30. In this example, each of the control systems 63A, 63B is merely a place where control and logic can occur.

Alternatively, for example, the control of data can occur in just the ports 28 with the separate port control systems 63A, or just the interfaces 30 with the interface control systems 63B.

As an overview, in one embodiment, the port control systems 63A use a switching algorithm in which all data packets stored in the buffer 28B of each port 28 of a given priority are read out sequentially without waiting to see if a particular packet is accepted or rejected at the intended destination port. Stated in another fashion, each data packet in the buffer 28B of the port 28 is sent sequentially without waiting for acknowledgements or aborts. In this embodiment, the data packets in each port 28 are read out sequentially with the highest priority data packets granted transmission before the lower priority data packets. For example, data packets with priority 1 in the port will be transmitted before data packets with priority 0 in the port. In this example, if the port only has two data packets with priority 1 and three data packets with priority 0, the two priority 1 data packets will be sequentially sent and then the three priority 0 data packets will be sequentially sent without waiting to see if a particular packet is accepted or rejected at the intended destination port. This algorithm used by the port control system 63A can be referred to as a “burst read algorithm”.

In this design, the acceptance or rejection of a particular data packet is determined later when the source port receives either an acknowledgment or abort signal from the intended destination port for each packet that had been read out. This architecture is a simple, space-efficient solution to head-of-line blocking for packets within the input buffer of a particular priority. This burst read algorithm can provide a significant performance increase in randomized traffic as it allows packets to be transmitted when otherwise those packets could be blocked by a packet at the front of the queue that is waiting for a congestion at its intended destination port to be resolved.

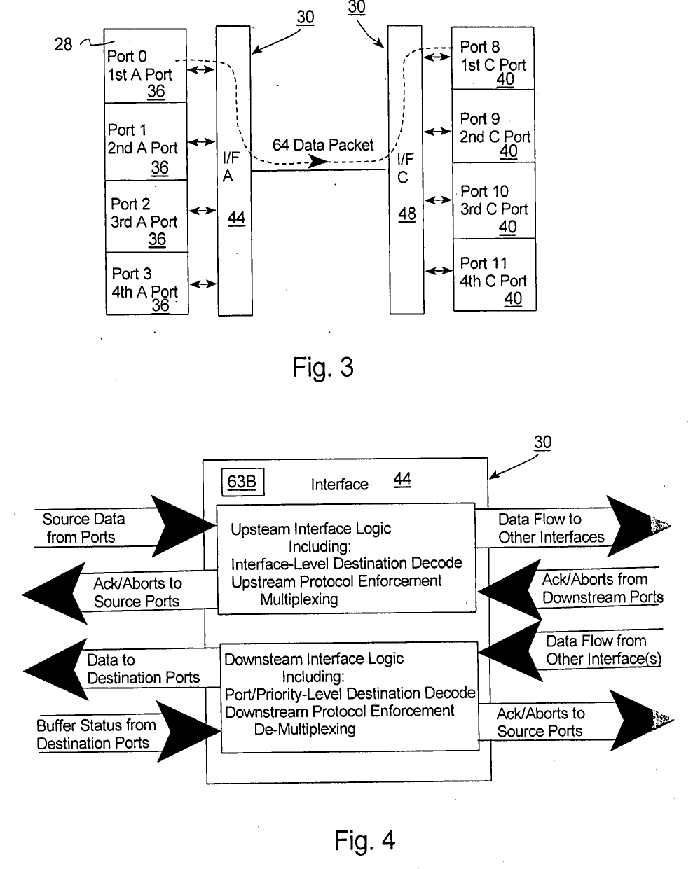

FIG. 3 is a simplified illustration of how a data packet 64 (illustrated with dashed lines) can be transferred from one port to another port between two interfaces 30. In this embodiment, the data packet 64 is transferred from the first A port 36 to the first C port 40. For clarity, only the A ports 36, the A interface 44, the AC connector 54, the C interface 48, and the C ports 40 are illustrated in FIG. 3. In this example, the data packet 64 starts at the first A port 36, and is sequentially transferred to the A interface 44, the AC connector 54, the C interface 48, and the first C port 40.

The port at which the data packet 64 starts (the first A port 36 in the previous example) can be referred to as the “source port”, while the port in which the data packet 64 is directed (the first C port 40 in the previous example) can be referred to as the “destination port”. Further, the interface 30 which is sending the data packet 64 is referred to as the upstream interface (the A interface 44 in the previous example) and the interface 30 which is receiving the data packet 64 is referred to as the downstream interface (the C interface 48 in the previous example).

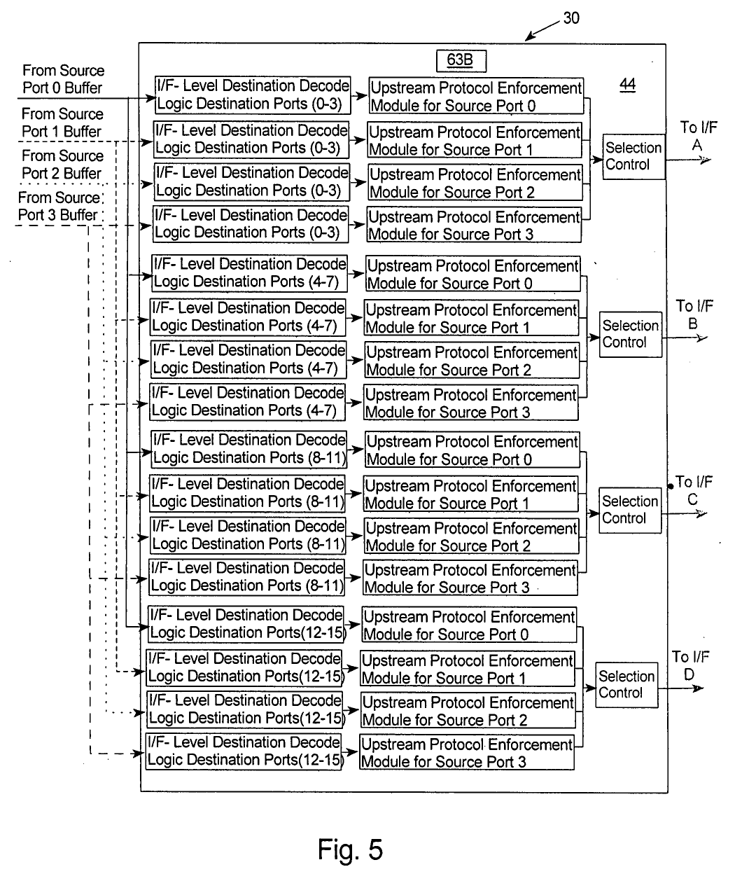

In one embodiment, each interface 44-50 contains logic that is used by the interface control system 63B for both upstream and downstream data since each port 28 can be both a source port and destination port. More specifically, FIG. 4 illustrates possible data flow into and out of one interface 30 (e.g. the A interface 44). In this example, the interface 30 includes upstream interface logic for when the interface 30 is an upstream interface (sending data to another interface) and downstream interface logic for when the interface 30 is a downstream interface (receiving data from another interface). In one embodiment, the upstream interface logic includes (i) interface-level destination decode, (ii) upstream protocol enforcement, and (iii) multiplexing; and the downstream interface logic includes (i) port/priority-level destination decode, (ii) downstream protocol enforcement, and (iii) de-multiplexing.

With this design, when data packets from one or more source ports (not shown in FIG. 4) connected to the interface 30 are received by the interface 30, the upstream interface logic directs the data flow to the destination interface (not shown in FIG. 4). Subsequently, the upstream interface logic receives the associated acknowledgements or aborts from the destination ports (not shown in FIG. 4) through the destination interfaces (not shown in FIG. 4) and the upstream logic transfers the associated acknowledgements or aborts to the respective source ports.

Further, when the interface 30 is a downstream interface, data flow from one or more source ports (not shown in FIG. 4) through one or more upstream interfaces (not shown in FIG. 4) is received by the illustrated interface 30. The downstream logic controls the data flow so that the data flows to the desired destination ports (not shown in FIG. 4) connected to the illustrated interface 30. Subsequently, buffer status from the destination ports is transferred to the illustrated interface 30 and the downstream interface logic sends the associated acknowledgements or aborts to the source ports via one or more of the upstream interfaces.

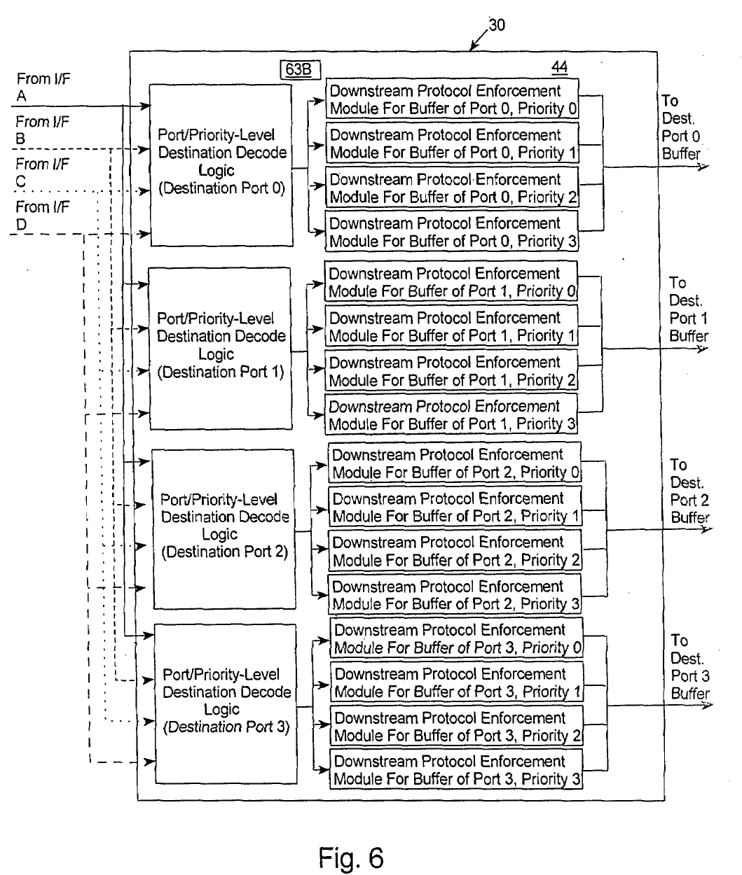

FIG. 5 illustrates the upstream interface logic blocks for one of the interfaces 30, namely the A interface 44. The other interfaces 46, 48, 50 can utilize similar logic to that illustrated in FIG. 5. In this example, (i) the interface control system 63B of the A interface 44 uses the upstream interface logic to control the flow of data packets from ports 0-3 that are directed to ports 0-3 of the A interface; (ii) the interface control system 63B of the A interface 44 uses the upstream interface logic to control data packets from ports 0-3 that are directed to ports 4-7 of the B interface; (iii) the interface control system 63B of the A interface 44 uses the upstream interface logic to control data packets from ports 0-3 that are directed to ports 8-11 of the C interface; and (iv) the interface control system 63B of the A interface 44 uses the upstream interface logic to control data packets from ports 0-3 that are directed to ports 12-15 of the D interface.

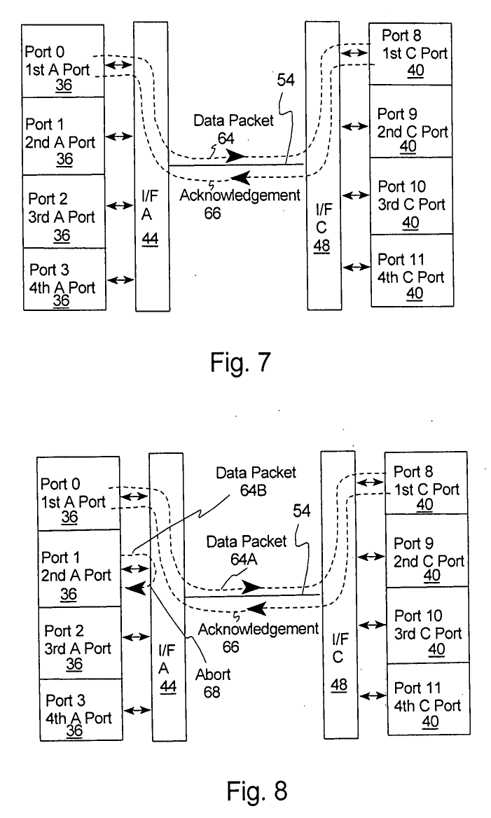

FIG. 6 illustrates the downstream interface logic blocks for one of the interfaces 30, namely the A interface 44. The other interfaces 46, 48, 50 can utilize similar logic to that illustrated in FIG. 6. In this example, (i) the interface control system 63B of the A interface 44 uses the downstream interface logic to control data packets from interfaces A-D to destination port 0; (ii) the interface control system 63B of the A interface 44 uses the downstream interface logic to control data packets from interfaces A-D to destination port 1; (iii) the interface control system 63B of the A interface 44 uses the downstream interface logic to control data packets from interfaces A-D to destination port 2; and (iv) the interface control system 63B of the A interface 44 uses the downstream interface logic to control data packets from interfaces A-D to destination port 3.

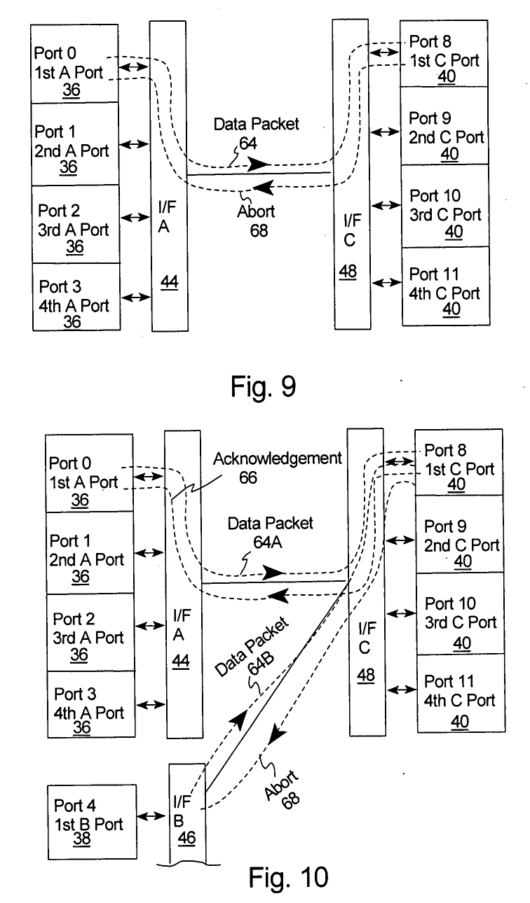

FIG. 7 illustrates the basic flow for a data packet 64 from the first A port 36 to the first C port 40 and the flow of its acknowledgement 66 response. In this example, the data packet 64 starts at the first A port 36, and is sequentially transferred to the A interface 44, the AC connector 54, the C interface 48, and the first C port 40. Next, the acknowledgement 66 is sequentially transferred from the first C port 40, the C interface 48, the AC connector 54, the A interface 44, and the first A port 36.

FIGS. 8-10 each illustrate possible data flow for a data packet with three potential unique abort responses. More specifically, FIG. 8 illustrates an example in which the first A port 36 is sending a data packet 64A to the first C port 40, and the second A port 36 is also attempting to send a data packet 64B to the first C port 40 with the same priority as the first A port 36. In this example, the upstream logic of the upstream interface (A interface 44 in this example) recognizes the collision, allows the data packet 64A to be sent from the first A port 36 to the first C port 40 and sends an abort response 68 to the second A port 36. Subsequently or concurrently, the acknowledgement 66 is independently transferred from the first C port 40 to the first A port 36. In this embodiment, the A interface 44 has selected the data packet 64A from the first A port 36 over the data packet 64B from the second A port 36. For example, (i) the data packet 64A from the first A port 36 could have the same priority and had been chosen before the data packet 64B from the second A port 36, or (ii) some other elaborate fairness algorithm could have been used.

FIG. 9 illustrates an example in which the first A port 36 was sending a data packet 64 to the first C port 40, but the first C port 40 has no ability to receive the data packet 64 due to output buffer 28B (illustrated in FIG. 2) of the first C port 40 being filled, lack of tracking ability, or other reason. In this example, an abort response 68 is sent from the first C port 40 to the first A port 36.

FIG. 10 illustrates an example in which that the first A port 36 is sending a data packet 64A to the first C port 40, and the first B port 38 is also attempting to send a data packet 64B to the first C port 40 with the same priority as the first A port 36. In this example, the downstream logic of the downstream interface (interface C in this example) recognizes the collision and sends an abort response 68 to the first B port 38. Subsequently or concurrently, the acknowledgement 66 is independently transferred from the first C port 40 to the first A port 36.

In this example, the C interface 48 has selected the data packet 64A from the first A port 36 over the data packet 64B from the first B port 38. For example, (i) the data packet 64A from the first A port 36 could have the same priority and had been chosen before the data packet 64B from the first B port 38, or (ii) some other elaborate fairness algorithm could have been used.

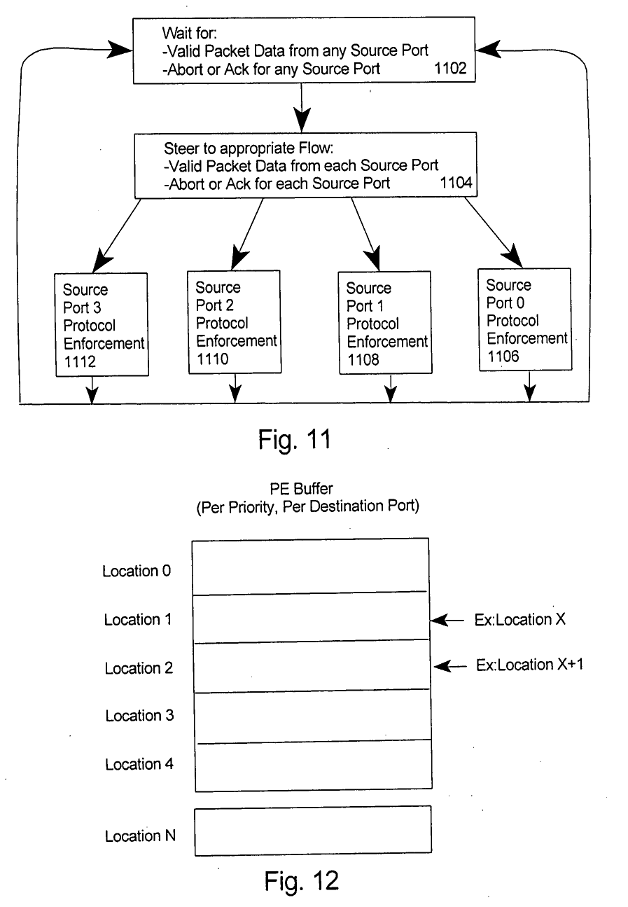

FIGS. 11 and 12 illustrate the flow of the upstream protocol enforcement (PE) logic for one of the port groups. More specifically, FIG. 11 illustrates the flow of the upstream protocol for one of the interfaces (e.g. the A interface), and FIG. 12 illustrates the protocol enforcement buffer structure for one source port that is part of the port group. These Figures will be described as the upstream protocol for the A port group. However, the same upstream protocol can be used for the other port groups.

As can be seen in FIG. 11, in this example, the PE logic of the interface supports and directs the flow of data to and from the possible source ports (any of the A ports (ports 0-3)). In this embodiment, at block 1102, the interface (the A interface) waits for (i) valid packet data from any source port (any of the A ports (ports 0-3)) or (ii) an abort or acknowledgement for any source port (any of the A ports (ports 0-3)). At block 1104, upon receipt of valid packet data, an abort, or an acknowledgement, the interface (the A interface) steers the information to the appropriate source port(s) (one of the A ports (ports 0-3)) at blocks 1106, 1108, 1110, or 1112. More specifically, in FIG. 11, block 1106 represents the protocol enforcement logic of source port 0; block 1108 represents the protocol enforcement logic of source port 1; block 1110 represents the protocol enforcement logic of source port 2: and block 1112 represents the protocol enforcement logic of source port 3. It should be noted that with the decentralized control system disclosed herein, the protocol enforcement logic for each of the source ports 0-3 is operating concurrently and independently of each other and each of the source ports 0-3 takes care of its own packet transfers.

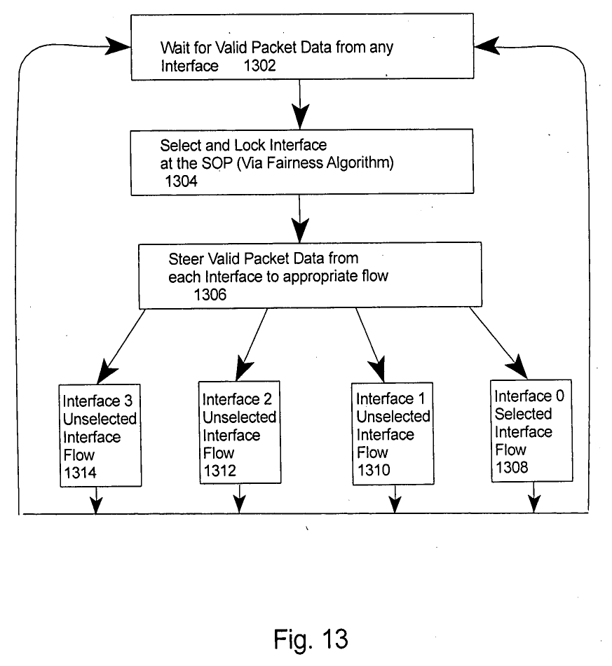

FIG. 13 illustrates the flow of the downstream protocol enforcement (PE) logic for one of the port groups. More specifically, FIG. 13 illustrates the flow of the downstream protocol for one of the destination interfaces (e.g. the A interface). This Figure will be described as the downstream protocol for the A port group. However, the same downstream protocol can be used for the other port groups.

As can be seen in FIG. 13, in this example, the PE logic of the interface supports and directs the flow of data to and from the possible destination ports (any of the A ports (ports 0-3)). In this embodiment, at block 1302, the downstream interface waits for valid packet data from any upstream interface. At block 1304, upon receipt of valid packet data, the downstream interface selects and locks the interface at the start of the packet (“SOP”) via some fairness algorithm. At block 1306, the interface steers the valid packet data to the appropriate destination port(s). In FIG. 13, block 1308 represents the selected interface protocol enforcement, and blocks 1310, 1312, 1314 represent the unselected interface protocol enforcement. In this embodiment, the selected interface is the one that is locked to the protocol enforcement logic and the unselected interfaces are not locked to the protocol enforcement logic.

It should be noted that with the decentralized control system disclosed herein, the PE logic for each of the destination interfaces is operating concurrently and independently of each other and each of the destination interfaces takes care of its own packet transfers. As can be seen from FIG. 13, there are multiple, concurrent interface flows running at once.

In this example, the switch includes four interfaces and there are four interface flows running concurrently. Alternatively, in the switch can have more the four interfaces and more than four interface flows running concurrently.

In certain embodiments, the present switching algorithms provides high performance bandwidth while ensuring that all of the ports are serviced fairly. In many applications, the specific data flow that a switch will have to transfer is constantly changing, and the specifics are frequently evolving. The present switching algorithms are designed to handle various manners of traffic.

The initial goal of the switching algorithms was high performance with fairness during completely randomized traffic. However, many switches have a more uniform traffic flow such as in a backplane operation. This type of traffic has a structure where many ports attempt to send data packets to one port (the backplane port, for example). In certain integrated circuits, backplane traffic is a significant portion of the overall data flow through the switch, although there is always a component of the data flow that may be random (such as control plane traffic).

In certain embodiments, the switching algorithm provides fair, high performance switching in a randomized environment while also having the architecture that provides good performance in backplane traffic.

In one embodiment, the switching algorithm recognizes the presence of backplane data flow and adapts so that data is efficiently transferred in the presence of backplane data flow. This solution also had to be able to quickly revert to the nominal algorithm in the case the traffic changed and was no longer just backplane traffic.

One enhancement is to the arbitration between ports in a port group. In the switch 14 illustrated in FIG. 2, four ports 28 shared a common interface 30 that is designed to support the maximum combined input bandwidth of the four ports 28. The initial architecture for the switching algorithm that determined usage of this interconnect was such that when a port was silent (had no data to transmit) the bandwidth normally reserved for that port would be divided up amongst the source ports that had data to transmit. For example, if all of the ports have data to transmit, each of the ports would get 2.5 gigabits/second for a 10 gigabit/second system. Alternatively, (i) if only three ports have data to transmit, each of the ports would get 3.3 gigabits/second for a 10 gigabit/second system, (ii) if only two ports have data to transmit, each of the ports would get 5 gigabits/second for a 10 gigabit/second system, or (iii) if only one port has data to transmit, this port would get 10 gigabits/second for a 10 gigabit/second system.

In a backplane environment, multiple source ports are trying to send data to the same destination port. In the present invention, whenever two or more source ports (of a particular port group) are competing for the same destination port, the switching algorithm enforces a fairness algorithm that would service one of them while rejecting the others.

With the burst read algorithm as defined above, the rejected source ports would continue trying to access the destination port due to the distributed nature of the switch architecture but would only be granted access once the source port that was transmitting finished its packet and the fairness algorithm then selected a different source port in the group. The continued attempts to access a destination port that is servicing some other source port would take up bandwidth in the connector that the four ports share. This bandwidth is wasted until the packet attempting to be transmitted is actually able to be received by the output port. During backplane traffic, this can be a major cost such as when all four of the source ports in a group are vying for the same destination port.

In one embodiment, if two or more source ports (of a particular port group) are competing for the same destination port with the same priority, the switching algorithm of the source interface stops allocating bandwidth over the connector to one of the source ports for that particular priority and that particular destination. In this embodiment, for example, if the first A port is attempting to send a first data packet to the first B port at the same time and with the same priority that the second A port is attempting to send a second data packet to the first B port, the switching algorithm of the A interface stops trying to send the second data packet until an acceptance is received by the first A port. Stated in another fashion, if two source ports of a particular port group are attempting to send data to the same destination port, with the same priority, the switching algorithm at the source interface stops one of the source ports from sending the data with that priority to that particular destination port until the other data has been sent. With this design, the bandwidth reserved for the second A port can be used to transfer the first data packet to expedite the data transfer to the first B port. Stated in another fashion, this allows for the reallocation of the bandwidth that would have been wasted by the second A port to the other A ports, including the first A port.

In this embodiment, the logic of the upstream interface recognizes that the packets from the ports in the port group will collide. Instead of retrying itself and taking up bandwidth, the rejected port turns itself ‘invisible’ to the algorithm controlling access to the shared connector. This allows the bandwidth of the rejected port to be reallocated. When this is done for all three of the ports in the port group that were not granted access to the destination port, this allows all the bandwidth of the connector to be given to the one source port that was accepted. Invisibility is cleared whenever an ‘end of packet’ is seen which will allow all the source ports to attempt access to the destination port and the fairness algorithm to select one.

This solution improves the bandwidth for the connector while not changing the fundamental architecture of the switch. Without wholesale changes to the switching algorithm, the invisibility enhancement allows the algorithm to adapt to a high-collision traffic environment such as a backplane environment while not impacting regular traffic since only those packets that are rejected because of a collision with other ports in the group going to the same destination with the same priority are made invisible.

Another option for enhancement of the switching algorithms for a backplane traffic environment is called backplane traffic mode. As discussed above, the burst reading function can have a negative performance impact in a backplane traffic environment. In a situation where all the packets in a source port buffer (for a given priority) have the same destination (such as the case would be in a backplane traffic environment) then burst reading may cause the source port to attempt to transfer the wrong packet (out of order) if the source port is allowed to just continue burst reading continuously, thereby using bandwidth that otherwise could be allocated to send other data packets. This can cause a reduction in performance of the switch.

In this embodiment, if one of the ports has a plurality of data packets to send to the same destination port, with the same priority, the switching algorithm begins sequentially sending the data packets. However, if an abort is received, the switching algorithm halts the burst read function and quits sending the data packets to that destination port with that priority until an acknowledgement is received from the destination port for that aborted packet. With this design, the switching algorithm prevents the data packets that are out of order from being sent because these out of order data packets will not be accepted out of order and these out of order data packets, if sent, will use resources that can be allocated for sending other packets.

In this example, if the first A port is attempting to send a first data packet and a second data packet sequentially to the first B port and the data packets have the same priority, if an abort is received for the first data packet, the switching algorithm of the source port stops the burst function for the first A port, for that priority, and waits until an acknowledgement is received for the first data packet prior to sending the second data packet. Stated in another fashion, in the backplane traffic mode, if an abort is received, the logic of the source port turns off the burst read function for the source port, for that priority, when all the packets in the source port buffer are destined for the same destination port, provided the source port has packets in the packet tracker positions. The progression from one packet tracker position to the next to initiate the reading out of the packet, in backplane traffic mode, is made when the packet that was read out gets acknowledged by the destination port. With this design, the switching algorithm at the source port prevents the data packets that are out of order from being sent because these out of order data packets will use resources that can be allocated for sending other packets.

While the particular switch as herein shown and disclosed in detail are fully capable of obtaining the objects and providing the advantages herein before stated, it is to be understood that they are merely illustrative of one or more embodiments and that no limitations are intended to the details of construction or design herein shown other than as described in the appended claims.

What is claimed is:

1. A data switch that transfers data, the data switch comprising:
an A port group that includes an A interface, a first A port that is electrically connected to the A interface, and a second A port that is electrically connected to the A interface, the first A port being adapted to receive data;
a B port group that includes a B interface, a first B port that is electrically connected to the B interface, and a second B port that is electrically connected to the B interface; and
an AB connector that directly connects the A interface to the B interface so that data from the first A port is transferred from the A interface to the B interface via the AB connector.

2. The data switch of claim 1 further comprising a C port group that includes a C interface, a first C port that is electrically connected to the C interface, and a second C port that is electrically connected to the C interface; an AC connector that directly connects the A interface to the C interface, and a BC connector that directly connects the B interface to the C interface.

3. The data switch of claim 2 further comprising a D port group that includes a D interface, a first D port that is electrically connected to the D interface, and a second D port that is electrically connected to the D interface; an AD connector that directly connects the A interface to the D interface, a BD connector that directly connects the B interface to the D interface, and a CD connector that directly connects the C interface to the D interface.

4. The data switch of claim 1 wherein the AB connector is sized to support a maximum combined input bandwidth of the A ports.

5. The data switch of claim 1 wherein the A port group includes a third A port that is electrically connected to the A interface, and the B port group includes a third B port that is electrically connected to the B interface.

6. The data switch of claim 5 wherein the A port group includes a fourth A port that is electrically connected to the A interface, and the B port group includes a fourth B port that is electrically connected to the B interface.

7. The data switch of claim 1 further comprising a control system that utilizes a switching algorithm that controls the transfer of data packets between the ports, wherein each of the ports includes a buffer, and wherein the switching algorithm includes a burst function that causes each of the ports to sequentially send all of the data packets in the respective buffer, per priority, without waiting for a response.

8. The data switch of claim 7 wherein if the first A port is attempting to send a first A data packet to the first B port at the same time that the second A port is attempting to send a second A data packet having the same priority as the first A data packet to the first B port, the switching algorithm stops the burst function for that priority, and for first B port so that the second A port stops sending the second A data packet to the first B port until an acceptance is received by the first A port.

9. The data switch of claim 7 wherein if the first A port is attempting to sequentially send a first data packet and a second data packet with the same priority to the first B port, the switching algorithm stops the burst function for that priority if an abort is received for the first data packet and waits until an acknowledgement is received for the first data packet prior to sending the second data packet.

10. The data switch of claim 1 wherein each of the ports includes a port control system that controls the transfer of data between the ports.

11. A data switch that transfers data, the data switch comprising:
a plurality of ports, each of the ports including a buffer; and
a control system that utilizes a switching algorithm that controls the transfer of data packets between the ports, the switching algorithm including a burst function that causes each of the ports to sequentially send all of the data packets in the respective buffer, per priority, without waiting for a response.

12. The data switch of claim 11 wherein the control system is a distributed system that includes a plurality of port control systems, with each port control system controlling the transfer of data from one of the ports.

13. The data switch of claim 11 further comprising an A interface, a B interface, and an AB connector that directly connects the A interface to the B interface; wherein the A interface and at least two of the ports define an A port group; and wherein the B interface and at least two of the ports define a B port group.

14. The data switch of claim 13 wherein if one of the ports of the A port group is attempting to send a first A data packet to one of the ports of the B port group at the same time that another of the ports of the A port group is attempting to send a second A data packet with the same priority as the first A data packet to the same port of the B port group, the switching algorithm stops the burst function for that priority and for that same port of the B port group so that the second A port stops sending the second A data packet to that same port of the B port group with that priority until an acceptance is received by the first A port.

15. The data switch of claim 13 wherein if one of the ports of the first A port is attempting to sequentially send a first data packet and a second data packet to same port of the B port group and the data packets have the same priority, the switching algorithm stops the burst function for that priority if an abort is received for the first data packet and waits until an acknowledgement is received for the first data packet prior to sending the second data packet.

16. A method for transferring data, the method comprising the steps of:
providing an A port group that includes an A interface, a first A port that is electrically connected to the A interface, and a second A port that is electrically connected to the A interface, the first A port being adapted to receive data;
providing a B port group that includes a B interface, a first B port that is electrically connected to the B interface, and a second B port that is electrically connected to the B interface; and
directly connecting the A interface to the B interface with an AB connector so that data from first A port is transferred from the A interface to the B interface via the AB connector.

17. The method of claim 16 further comprising the steps of providing a C port group that includes a C interface, a first C port that is electrically connected to the C interface, and a second C port that is electrically connected to the C interface; directly connecting the A interface to the C interface with an AC connector; and directly connecting the B interface to the C interface with a BC connector.

18. The method of claim 16 wherein the step of providing an A port group includes providing a third A port that is electrically connected to the A interface.

19. The method of claim 16 further comprising the step of sequentially sending out all of the data packets in a buffer, per priority, in each port without waiting for a response.
